(19) United States
(12) Patent Application Publication
(10) Pub. No.: US 2014/0244346 A1
(43) Pub. Date: Aug. 28, 2014

(54) REAL ESTATE TRANSACTION MANAGEMENT PLATFORM

(71) Applicant: Jon Silberman, Houston, TX (US)

(72) Inventor: Jon Silberman, Houston, TX (US)

(73) Assignee: Assistant Broker LLC, Houston, TX (US)

(21) Appl. No.: 13/776,919

(22) Filed: Feb. 26, 2013

(51) Int. Cl. G06Q 30/02; G06Q 50/16

(52) U.S. Cl. CPC G06Q 30/0201; G06Q 50/16
USPC 705/7.29; 705/26.41

(57) ABSTRACT

Methods, devices, and systems for real estate transaction management. Methods may include generating and displaying parts of one or more data sets based on data including a proposal and one more counterproposals for a transaction of real property. The method may include performing data analysis on at least part of the data of one or more of the proposal and counterproposals and generating at least one negotiation analysis data set; and providing at least part of the negotiation analysis data set to a related party. The negotiation analysis data set may be determined in dependence upon a procurement data set associated with a procurement party and representing at least part of a procurement real estate proposal for real property, and a property holder data set associated with a property holder party and representing at least part of a property holder real estate proposal for the real property.

### BACKGROUND OF THE DISCLOSURE

Complex transactions often involve multiple parties in a process of bidding and counter-bidding to establish a transfer of rights (ownership, leases, etc.) in exchange for financial and/or non-financial consideration. For example, real estate transactions include a number of variables that may be analyzed regarding the property (or properties) and consideration instruments.

In a typical real estate transaction, a first party may submit or solicit an offer from a second party. The second party may ignore, accept, or provide a counter offer. If the negotiation continues, the first party receives a counter offer and is placed in the same position as the second party (i.e. option of ignoring, accepting, or counter-offering). Each offer (or counter offer) may be considered a proposal. This process may have multiple iterations and proposals may be presented to multiple parties through the transaction process. The process may also involve multiple properties being considered, so that alternative or additional properties may be considered simultaneously. Organizing and analyzing the amount of and variation of the data coming from multiple parties and through multiple iterations with multiple properties can be confusing and time consuming. This disclosure provides for an apparatus and method for facilitating communications between parties of a real estate transaction and generating and displaying data relevant to performing real estate transactions (e.g., leases, purchase/sale transactions).

### SUMMARY OF THE DISCLOSURE

In aspects, this disclosure generally relates to management of real estate transactions (e.g., leases, purchase/sale transactions). More specifically, this disclosure relates facilitation and management of communications and analysis of information regarding real estate transactions. Aspects of the disclosure provide for systems, devices, and methods for facilitating communications between prospective parties of a real estate transaction and generating and displaying data relevant to negotiating real estate transactions. Relevant data may include data facilitating comparison of various proposals by various parties according to various characteristics, including comparisons of the underlying property involved in each proposal.

In one general embodiment, a method for real estate transaction management is performed by execution of a computer-readable program code by at least one processor of at least one computer system. The method includes generating at least one negotiation analysis data set using the at least one processor to analyze: a procurement data set associated with a procurement party and representing at least part of a procurement real estate proposal for real property, and a property holder data set associated with a property holder party and representing at least part of a property holder real estate proposal for the real property. The method may also include providing at least part of the negotiation analysis data set to at least one of i) the procurement party, ii) an agent of the procurement party, iii) the property holder party, and iv) an agent of the property holder party.

The property may be a commercial real estate property. The real estate proposals may relate to leasing of the property or to buying of the property. The property holder real estate proposal may be in response to the procurement real estate proposal, or the procurement real estate proposal may be in response to the property holder real estate proposal.

The method may also include generating a subsequent data set representing a counterproposal to at least one of i) the procurement party real estate proposal, and ii) the property holder real estate proposal using at least a portion of the negotiation analysis data set. Generating the subsequent data set may include modifying the negotiation analysis data set using additional proposal information. The negotiation analysis data set may include an estimated optimal counterproposal.

The method may also include storing negotiation information pertaining to parties of prior negotiations, or storing negotiation information pertaining to parties of prior negotiations as a negotiation history associated with a respective party of the parties of prior negotiations. The estimated optimal counterproposal may be generated in dependence upon statistical information derived from an aggregation of stored negotiation information, or the estimated optimal counterproposal may be generated in dependence upon a stored negotiation history of at least one of i) the procurement party, and ii) the property holder party. The estimated optimal counterproposal may also be generated in dependence upon at least one of i) the procurement data set, and ii) the property holder data set; and at least one subsequent data set representing a counterproposal.

Generating the at least one negotiation analysis data set may include generating a comparison between the procurement data set and the property holder data set, or generating a comparison between the at least one negotiation analysis data set and at least one of i) the procurement data set, and ii) the property holder data set.

Providing the at least part of the negotiation analysis data set may be carried out by rendering the at least part of the negotiation analysis data set, such as, for example, by displaying text, images, animations, or video footage, or by playing audio such as words or music, or by any combination of the above. Providing the at least part of the negotiation analysis data set may include displaying at least one of: (i) a part of the procurement data set and (ii) a part of the property holder data set.

Generating at least one negotiation analysis data set may be carried out by using the processor to further analyze at least one additional data set comprising at least one of i) an additional procurement data set associated with an additional procuring party, and ii) an additional property holder data set associated with an additional property holder party.

Another general embodiment may include a system for real estate transaction management. The system may include a real estate negotiation management platform comprising at least one processor; a procurement brokerage server in communication with the real estate negotiation management platform, the procurement brokerage server configured to submit a procurement data set associated with a procurement party and representing at least part of a procurement real estate proposal for real property; a property holder brokerage server in communication with the real estate negotiation management platform, the property holder brokerage server configured to submit a property holder data set associated with a property holder party and representing at least part of a property holder real estate proposal for real property. The real estate negotiation management platform may be configured to generate, using the at least one processor, at least one negotiation analysis data set in dependence upon at least the procurement data set and the property holder data set; and provide at least part of the at least one negotiation analysis data set to at least one of i) the procurement brokerage server and ii) the property holder brokerage server. At least one of i) the procurement brokerage server and ii) the property holder brokerage server may be configured to enable access of the at least one negotiation analysis data set to at least one of i) the procurement party, ii) an agent of the procurement party, iii) the property holder party, and iv) an agent of the property holder party.

Another general system embodiment may include a procurement party client device in communication with the procurement brokerage server, the procurement party client device configured to enable rendering of the at least one negotiation analysis data set; a property holder party client device in communication with the property holder brokerage server, the property holder party client device configured to enable rendering of the at least one negotiation analysis data set. At least one of i) the procurement brokerage server and ii) the property holder brokerage server may be configured to enable access of the at least one negotiation analysis data set via rendering on at least one of i) the procurement party client device and ii) the property holder party client device. At least one of i) the procurement party client device and ii) the property holder party client device may be configured to enable generation of at least one of i) the procurement data set and ii) the property holder data set.

Another general system embodiment includes a real estate negotiation management platform comprising at least one processor; a procurement party client device in communication with the real estate negotiation management platform, the procurement party client device configured to submit a procurement data set associated with a procurement party and representing at least part of a procurement real estate proposal for real property; a property holder party client device in communication with the real estate negotiation management platform, the property holder party client device configured to submit a property holder data set associated with a property holder party and representing at least part of a property holder real estate proposal for real property. The real estate negotiation management platform may be configured to: generate, using the at least one processor, at least one negotiation analysis data set in dependence upon at least the procurement data set and the property holder data set; and provide at least part of the at least one negotiation analysis data set to at least one of i) the procurement brokerage server, ii) the property holder brokerage server. At least one of i) the procurement party client device and ii) the property holder party client device may be configured to enable access of the at least one negotiation analysis data set to at least one of i) the procurement party, ii) an agent of the procurement party, iii) the property holder party, and iv) an agent of the property holder party.

Another general system embodiment includes at least one processor; and a non-transitory storage medium, the medium storing instructions thereon that, when executed, cause the at least one processor to carry out any of the methods described above.

Another general system embodiment includes at least one processor; and a non-transitory storage medium, the medium storing instructions thereon that, when executed, cause the at least one processor to: receive and store a first data set representing at least part of a first proposal from a first party in a database; receive and store a second data set representing at least part of a second proposal from a second party in the database; generate a third data set using the at least one processor and the first data set; and display at least part of the third data set.

The medium may include instructions thereon that, when executed, cause the at least one processor to: display at least one of: (i) a part of the first data set and (ii) a part of the second data set. The medium may include instructions thereon that, when executed, cause the at least one processor to: modify the third data set using additional first party information. The medium may include instructions thereon that, when executed, cause the at least one processor to: generate a comparison between the first data set and at least one of: (i) the second data set and (ii) the third data set; and display at least part of the comparison. The medium may include instructions thereon that, when executed, cause the at least one processor to: generate a fourth data set using the processor and the second data set; modify the fourth data set using additional second party information; and display at least part of the fourth data set. The medium may include instructions thereon that, when executed, cause the at least one processor to: receive and store a fifth data set representing at least part of a third proposal from a third party in the database; generate a sixth data set using the at least one processor and the fifth data set; display at least part of the fifth data set.

The database may include at least one cloud-based resource. The first proposal may be one of: (i) a request for proposal and (ii) a landlord proposal. The data sets may include information related to a commercial real estate leasing proposal. The first party may be associated with one of a group consisting of: (i) a tenant and (ii) a landlord, and the second party may be associated with the other of the group. The second proposal may be in response to the first proposal.

Another general method embodiment includes a method of conducting commercial real estate transactions, the method being performed by execution of a computer-readable program code by at least one processor of at least one computer system, the method comprising: receiving and storing a first data set representing at least one proposal from a first party in a database; receiving and storing a second data set representing at least one proposal from at least one other party in the database; and displaying at least part of the first data set and at least part of the second data set.

The at least one other party may include a plurality of parties. The at least part of the second data set may be determined based on an identity of one of the plurality of parties. The method may include determining the at least part of the second data set to be displayed based on an identity of one of the plurality of parties; or generating a third data set using the at least one processor and at least part of one of: (i) the first data set and (ii) the second data set; or modifying the third data set using additional information from at least one of the parties; or displaying the third data set; or generating a comparison between the first data set and at least one of: (i) the second data set and (ii) the third data set; and displaying at least part of the comparison.

One embodiment according to the present disclosure includes a method of conducting commercial real estate transactions, the method being performed by execution of a computer-readable program code by at least one processor of at least one computer system, the method comprising: receiving and storing a first data set representing at least part of a first proposal from a first party in a database; receiving and storing a second data set representing at least part of a second proposal from a second party in the database; generating a third data set using the at least one processor and the first data set; and displaying at least part of the third data set.

Another embodiment according to the present disclosure includes a commercial real estate transaction system, the system comprising: at least one processor; and a non-transitory storage medium, the medium storing instructions thereon that, when executed, cause the at least one processor to: receive and store a first data set representing at least part of a first proposal from a first party in a database; receive and store a second data set representing at least part of a second proposal from a second party in the database; generate a third data set using the at least one processor and the first data set; and display at least part of the third data set.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals.

FIGS. 1A & 1B are data flow diagrams of real estate transaction management in accordance with embodiments of the present disclosure.

FIG. 2 is a diagram of a real estate transaction management system in accordance with embodiments of the present disclosure.

FIG. 3 sets forth a block diagram of an example information processing device used in embodiments of the present disclosure.

FIG. 4 shows a flow chart of an example method of conducting a real estate transaction in accordance with embodiments of the present disclosure.

FIGS. 5 & 6 show a graphical user interface in accordance with embodiments of the present disclosure.

FIGS. 7A-G illustrate a graphical user interface in accordance with embodiments of the present disclosure.

### DETAILED DESCRIPTION

This disclosure generally relates to complex transactions, such as, for example, real estate transactions. More specifically, this disclosure relates to supporting real estate transactions including negotiations pertaining to such transactions. Aspects of the disclosure provide for systems, devices, and methods for facilitating communications between prospective parties of a real estate transaction (e.g., lease, purchase/sale, etc.) and generating and displaying data relevant to negotiating real estate transactions.

Real estate transactions, generally, and commercial real estate transactions in particular, may have a high degree of complexity. Real estate transactions have a number of variables, such as, for example, variables relating to the property (e.g., square footage, improvement allowance), the parties (e.g., credit rating), compensation (e.g., rental rates), financing, security interests, and so on. Typical commercial real estate transactions may include a large number of property variables, such as total price, square footage, price per square foot, amenities, availability of utilities, build out options, build out prices, demographics, build out allowances, operating expenses, lease term, renewal options, expansion options, termination options, lease rates, build out costs, common area factors, rental abatement, and so on. Valuing each side of the transaction in dependence upon these variables can be cumbersome, time consuming, and prone to error.

Due to the number of variables and the intricacies of valuation, one or more aspects of the transaction may be negotiated. Often the party seeking to acquire the property (e.g., a prospective tenant or purchaser) and the party holding the property (e.g., landlord or seller) may exchange a series of offers and counteroffers. The party seeking to acquire the property (‘procurement party’) may conduct negotiations on several properties from various sellers/landlords with the intent of only one purchase/lease. Additionally or alternatively, the property holding party may conduct simultaneous negotiations with a number of procurement parties for the same property.

It may also be useful in some instances to compare multiple properties simultaneously. This may add additional complexity to the negotiation, which may include multiple properties each having multiple variables. Analysis of the negotiation may then include evaluating the respective values for any or all of the available variables for the multiple properties. Additionally, or in the alternative, analysis may include comparing values for any number of desired variables of the multiple properties against one another and/or against historical data for any or all of the multiple properties, alone or in aggregation.

When the parties become involved in a negotiation, each of the iterations of the negotiation process may use data acquired or presented during one or more previous iterations. The subsequent iterations may also involve additional data that was not present in previous iterations, including, but not limited to, one more of: i) results from analysis of data from previous iterations, ii) desires, requirements, and/or expertise of the parties, and iii) externally obtained data.

Management of the cumbersome volume of real estate data and the changes thereto during the negotiation process, and providing analysis to a party, which may be used to support or perform the generation of a counter-offer, may facilitate the transaction process, reduce errors, and enable better decision making as will be apparent from the embodiments below.

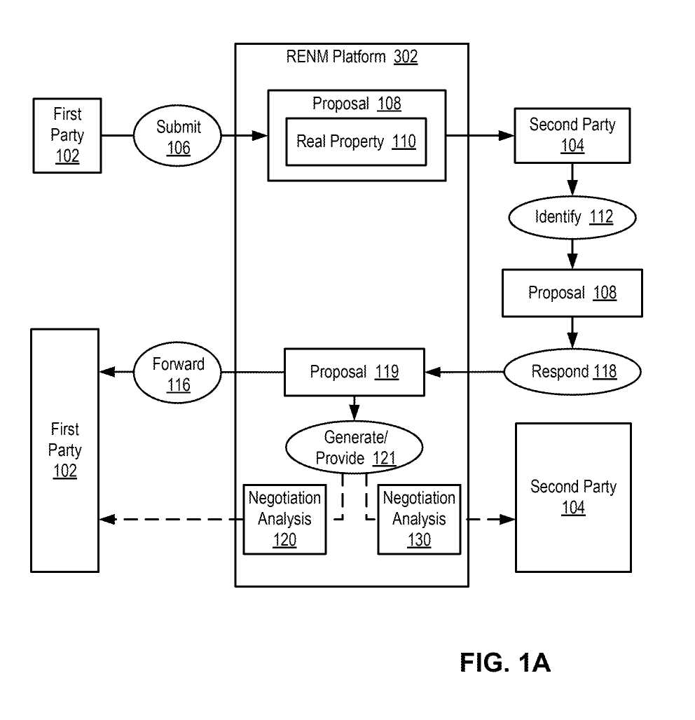

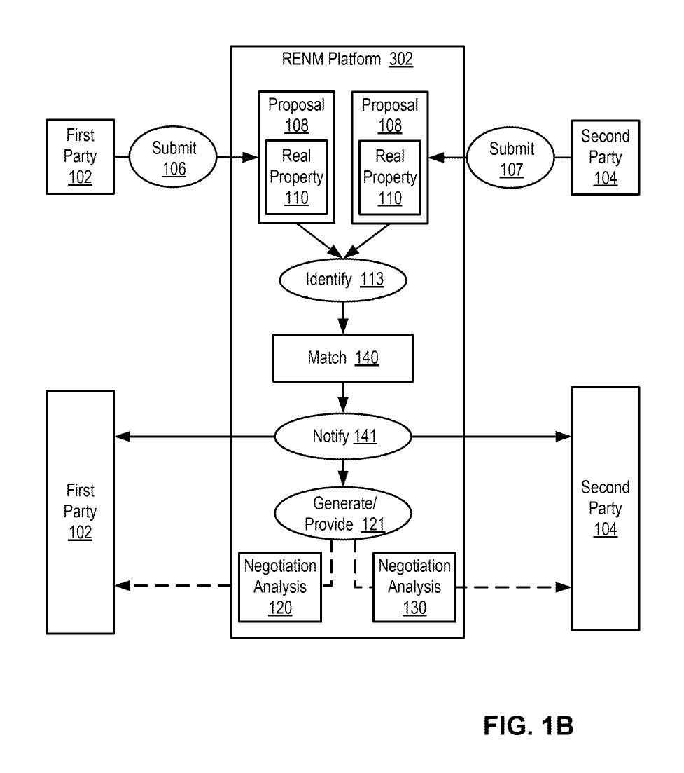

FIG. 1A is a data flow diagram of a real estate transaction management in accordance with embodiments of the present disclosure. Two prospective parties to a real estate transaction (e.g., a first party 102 and a second party 104) may use the real estate negotiation management (‘RENM’) platform 101. In various embodiments, the first party 102 may be the procurement party and the second party 104 may be the property holder party, or the first party 102 may be the property holder party and the second party 104 may be the procurement party.

The first party may submit (block 106) a proposal 108 to the RENM platform 101. Submitting the proposal (block 106) may be carried out by transmission of a data set representing the proposal. Example proposals may include requests for proposal (‘RFPs’), offers, counteroffers, listings, and so on as will be apparent by those of skill in the art. The proposal may relate to a transaction regarding real property, and thus contain an indication of the real property 110. The indication 110 may be specific to a certain property, to one of a number of generally similar properties belonging to a particular property holder party, to a selected group of multiple properties, or to any property meeting proposed criteria. In the last instance, submitting the proposal (block 106) may include posting the proposal 108 to the RENM platform 101 for general listing in a database of proposals for browsing or search by interested parties. Conversely, submitting a proposal specifically pertaining to one or more selected properties as described above (‘directed proposal’) may optionally be kept confidential. That is, a directed proposal may not be publicly disclosed.

The second party 104 identifies (block 112) the proposal 108 as being desirable, in that the second party determines that it is desirable to enter negations with the first party 102 for the property 110, with the proposal 108 being a starting point for negotiations. In some instances, the second party might also be provided the capability to identify the proposal 108 as being an acceptable offer without further negations (not shown).

Identifying the proposal 108 may be carried out with the help of search tools, automatic notification tools, or other sorting and filtering tools. Identification may also include manual selection of sorted or filtered sets of proposals. A data set representing the proposal may be transmitted to the second party 104. The data set may be sufficient for reconstruction of the proposal, or may cause or enable the retrieval of further information containing the remainder of the proposal. For example, clicking a link in an email or on a web page may enable viewing of and/or interaction with the proposal via a web browser. The second party 104 may then respond (block 118) to the identified proposal 114 with a proposal 119 (i.e., a ‘counterproposal’, representing a counter offer) through the RENM platform 101, which forwards the response counteroffer 119 to the first party 102 (block 116). Responding and transmitting (block 116, 118) may be carried out by transmission of a data set representing the proposal.

The RENM platform may further generate and provide (block 121) a negotiation analysis 120, 130 to at least one of the first party 102 and the second party 104. Negotiation analysis 120, 130 may be generated and/or provided before or after transmitting or responding (blocks 116, 118). The negotiation analysis 120, 130 may include additional proposal information, which may include information supplied by one of the parties, reference information, current economic or market information, and so on. Additional proposal information may include information generated by the RENM platform. For example, additional proposal information may include discounted cash flow information regarding one or more of the proposals.

The negotiation analysis 120, 130 may include a comparison between the procurement data set and the property holder data set; a comparison between the at least one negotiation analysis data set and at least one of i) the procurement data set, and ii) the property holder data set; and so on. The comparison is a graphical indicator of differences between proposals, which may include all, a standard subset, or a specifically selected set of proposal information or contract text including graphical difference indicia such as, for example, differences in font, text color or background color; underlining; arrows; symbols; text summaries; stylistic changes; graphs; charts; and so on. The comparison may include charts or graphs illustrating differences between proposals, indicia illustrating differences in text from comparable provisions, summaries illustrating differences in contract provisions, and so on. The comparison may include graphical indicia of differences between additional proposal information pertaining to one or more of the proposals, including additional proposal information generated by the RENM platform 101. For example, an economic comparison of proposals may include discounted cash flow analysis for the respective proposals to compare costs between them. In some embodiments, costs may be compared between one or more leasing options and one or more purchasing options. Purchasing options may include transactions for yet-to-be-constructed units.

Generating a negotiation analysis may be carried out by analyzing the data sets from the first party 102 and the second party 104 representing their respective proposals. The data sets may include a procurement data set associated with a procurement party, and a property holder data set associated with a property holder party. The negotiation analysis may be specifically tailored to the type of party (procurement party, property holder party, agent, purchaser, etc.), or to a certain party (John W. Doe, ABC Realty Agents, etc.), or may be identical for each of the procurement party and the property holding party.

The RENM platform 101 may further generate and provide a subsequent data set representing a counterproposal to at least one of the proposals. Generation of the counterproposal may be carried out in response to activation by a user through icon selection via a graphic user interface (e.g., point-and-click). The subsequent data set may be incorporated into or illustrated by the negotiation analysis 120, 130. The subsequent data set may be generated by modifying a proposal from a previous iteration or a negotiation analysis using additional proposal information, which may include information supplied by one of the parties, reference information, current economic or market information, and so on.

In some embodiments, the counterproposal may be an estimated optimal counterproposal. The estimated optimal counterproposal may be a suggested counterproposal synthesized according to rules adapted to provide a beneficial outcome to the negotiation. The rules may be configured such that the beneficial outcome is the highest chance of completing the transaction, the most favorable outcome for the party proposing the optimal counterproposal, a balance between these outcomes, or any other optimal outcome as desired by either party, their agents, or the system proprietor. The estimated optimal counterproposal may be generated in dependence upon statistical information derived from an aggregation of stored negotiation information pertaining to parties of prior negotiations; a stored negotiation history of at least one of the procurement party, and the property holder party; the procurement data set; the property holder data set; at least one subsequent data set representing a counterproposal; and the like.

In some aspects, the estimated optimal counterproposal may be presented to the user for editing/acceptance. For example, in particular embodiments, a counterproposal form may be presented to a user having one or more text fields pre-filled with estimated optimal values for negotiation. The user may modify or delete the values before submitting the counterproposal, or leave the default values as presented for submission. In other embodiments, a counterproposal “wizard” may guide the user in using the estimated optimal values through a series of questions. For example, the wizard may notify the user of the estimated optimal value and ask if the user wishes to use that value, enter another value, or leave the field blank. The counterproposal may be generated in dependence upon the user's input “answers” to these questions.

In one example negotiation, a user may send a first proposal indicating a value of a particular parameter (e.g., a price per square foot of $10) to a second party. If the second party sends a proposal in response having a different value for the parameter (e.g., a price per square foot of $11), an estimated optimal value for the ‘price per square foot’ parameter may be calculated by the RENM platform 101 and presented to the user. For example, the optimal value may be calculated by averaging the two values for the parameter, by incrementing the value by a predefined amount, and so on. In particular implementations, the estimated optimal value may be calculated by adjusting the average of the two values or the previous value with a combination of variables weighted according to market conditions. For example, an average of the two values ($10.50) may be adjusted by a seller's market factor (e.g., +$0.25) when seller's market conditions exist to calculate the estimated optimal value ($10.75).

Providing the negotiation analysis 120, 130 may be carried out by transmitting a data set representing the negotiation analysis. The data set may be in readable text format, or in a format for rendering (e.g., display, audio) by a web browser or by client software on a client device used by the respective party. The format of the data set may be a readily available standard format or may be proprietary.

FIG. 1B is a data flow diagram of a real estate transaction management in accordance with embodiments of the present disclosure. Two sets of prospective parties to a real estate transaction (e.g., a set of first parties 102 and a set of second parties 104) may use the real estate negotiation management (‘RENM’) platform 101. In various embodiments, the first party 102 may be the procurement party and the second party 104 may be the property holder party, or the first party 102 may be the property holder party and the second party 104 may be the procurement party.

A particular first party may submit (block 106) a first proposal 108 and a particular second party may submit (block 107) a second proposal to the RENM platform 101 for general listing in a database of proposals. Selection software executing on one or more processors of the platform 101 identifies a potential match 140 according to selection criteria and notifies at least one and optionally both of the first party and the second party (block 141). One of the parties may respond to the other party's proposal, as described above. The RENM platform 101 may generate and provide a negotiation analysis 120, 130 to at least one of the first party 102 and the second party 104 either after the response or, preemptively, upon notification of the match.

In other embodiments, a third party, a fourth party, and so on may join the negotiation on either side (i.e., as additional procurement parties or additional property holder parties).

When a procurement party and a property holder party have agreed on all negotiated terms, the negotiation is concluded. The RENM platform 101 may generate a confirmation notification (e.g., a confirmation email) for the two parties. In some embodiments, additional offline paperwork must be completed by the respective parties to enter the transaction. The RENM platform 101 may generate form documents for one or more parties using information acquired in the negotiation process, which may then be printed for signature.

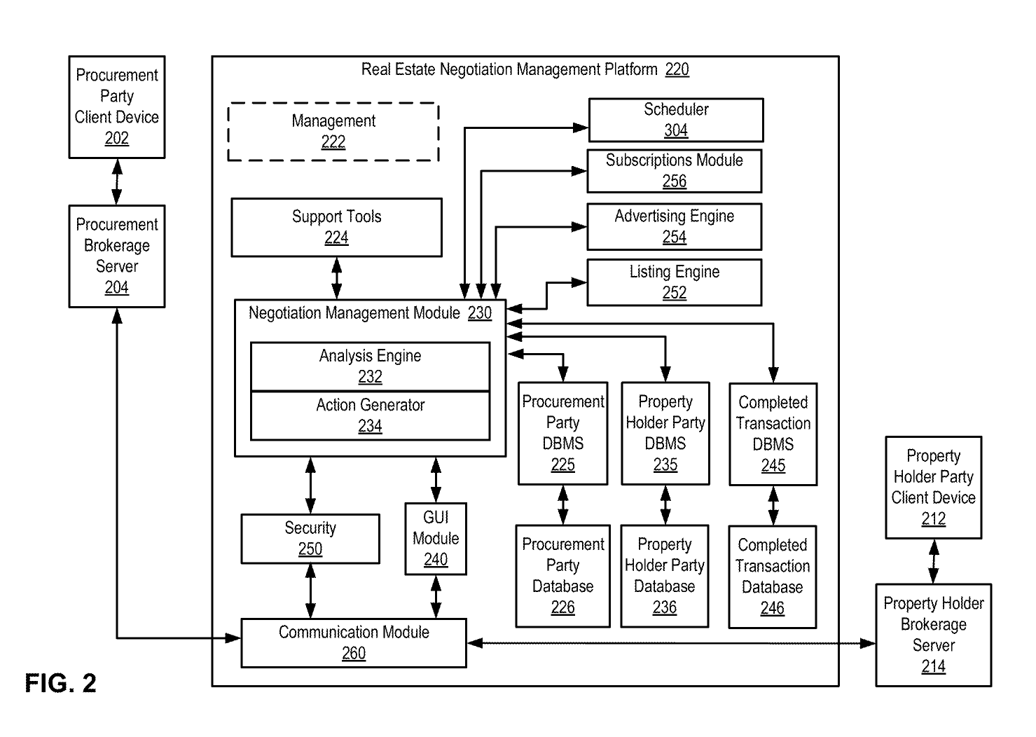

Embodiments of the present disclosure may be implemented as specifically configured real estate management processing devices. These devices may include software modules installed and running on one or more data processing systems (‘computers’). Each of the devices of FIG. 2 is implemented as a computer.

FIG. 2 is a diagram of a real estate transaction management system in accordance with embodiments of the present disclosure. The real estate transaction management system 200 includes a number of devices connected by networks for data communications. The system 200 includes wide area networks (‘WAN’), such as the Internet. In other embodiments, however, the devices of FIG. 2 may be connected by local area networks (‘LAN’s), intranets, internets, the Internet, wireless networks, cellular networks, or any other type of communication network, or combinations of these.

Referring to FIG. 2, a procurement party client device 202 is in connection with a procurement brokerage server 204, and is used by a procurement party (a prospective tenant or purchaser, or an agent representing the prospective tenant or purchaser). Similarly, a property holder client device 212 is in connection with a property holder device brokerage server 214, and is used by a property holder party (a property holder or an agent representing the property holder). Each of the brokerage servers 204, 214 is in connection with the RENM platform 220.

Procurement brokerage server 204 and property holder brokerage server 214 may include web servers and/or application servers connected to a database in local or remote storage. The brokerage servers 204, 214 may serve as a gateway for client device communication with the RENM platform 220. The brokerage servers 204, 214 may also store and manage account information or client preferences regarding respective clients (e.g., tenants, landlords), or information pertaining to local markets. Brokerage servers 204, 214 may also enable the services described below in connection with the RENM platform 220. For example, brokerage servers 204, 214 may provide a website enabling the generation and submission of proposals as described in further detail below via a World Wide Web interface using a typical Internet browser. Brokerage servers 204, 214 may also be real estate broker server used for listing local real estate.

In some instances, software modules executing on one or more processors of one of the brokerage servers 204, 214 may generate a proposal or accept a proposal from a client device, and generate a data set representing the proposal for use with the system of the present disclosure. The proposal data set may include parameter values, field-associated text, and so on. Generation of the data set may include reformatting, optical character recognition (‘OCR’) or other means of format conversion, or other preprocessing to ensure the proposal data set is system-compliant.

Client devices 202, 212 may be any of a desktop, workstation, laptop, smartphone, tablet, cellular telephone, and the like. Client devices 202, 212 may log in to their respective brokerage servers (by using a web browser or a client application, for example) to enable the respective parties to view listings, post listings, submit proposals, check for submitted proposals, use specialized tools to do research or search for properties, or to analyze proposals, submit counterproposals, and so on.

An example software architecture is illustrated with respect to the RENM platform 220. The RENM platform 220 includes a negotiation management module 230 for generating at least one negotiation analysis data set for a prospective transaction using at least one processor. The negotiation management module 230 may also provide at least part of the negotiation analysis data set to the brokerage servers 204, 214 for use of an agent or to be forwarded to a client device 202, 212. The negotiation management module 230 includes an analysis engine 232 and an action generator 234.

The negotiation management module 230 may generate the at least one negotiation analysis data set by analyzing, using the processor, a procurement data set associated with a procurement party and representing at least part of a procurement real estate proposal for real property, and a property holder data set associated with a property holder party and representing at least part of a property holder real estate proposal for the real property.

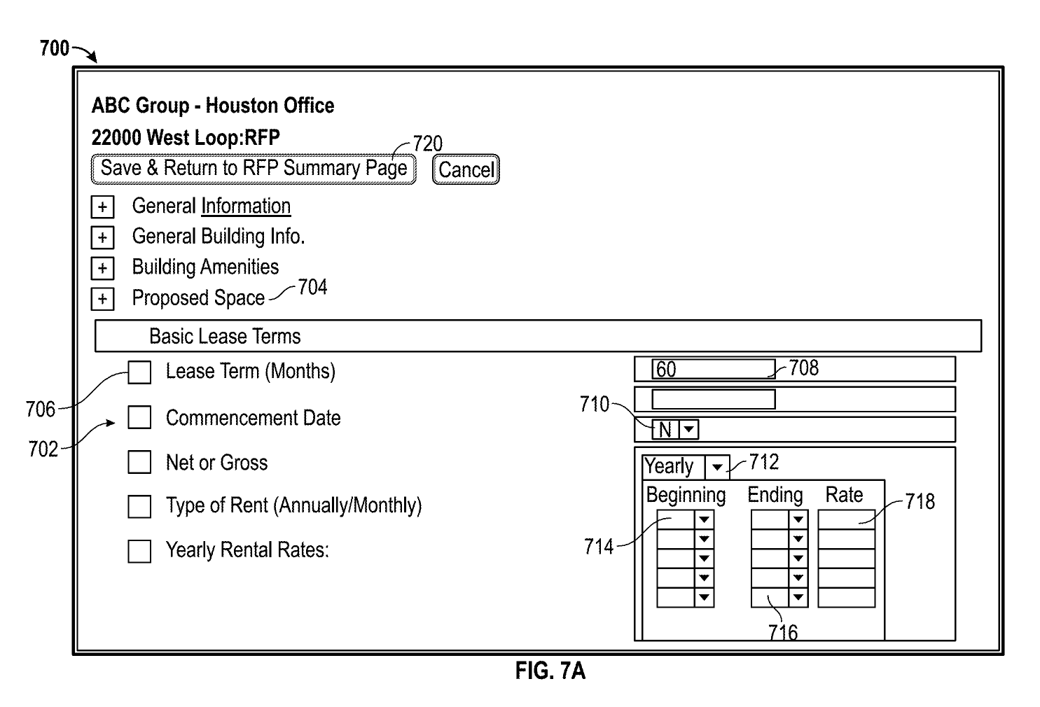

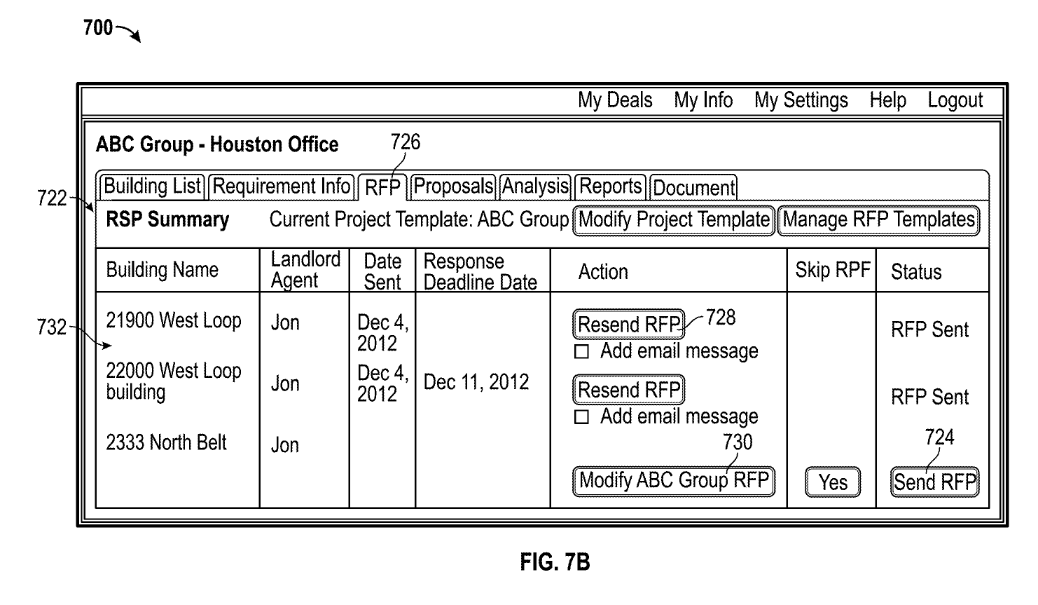

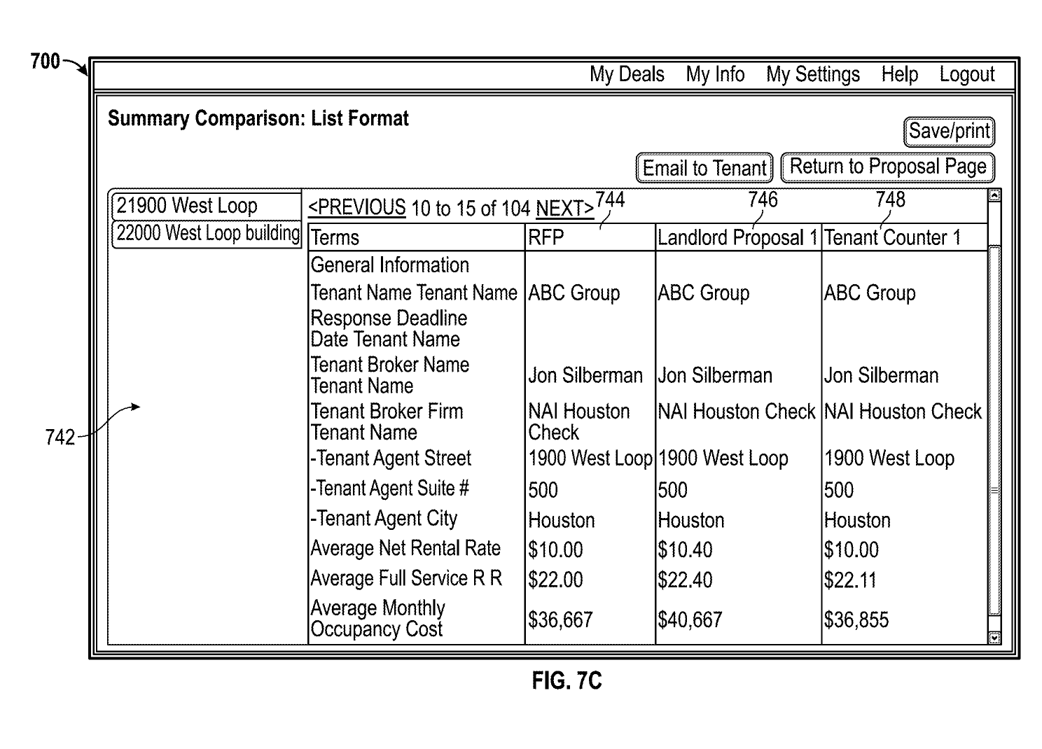

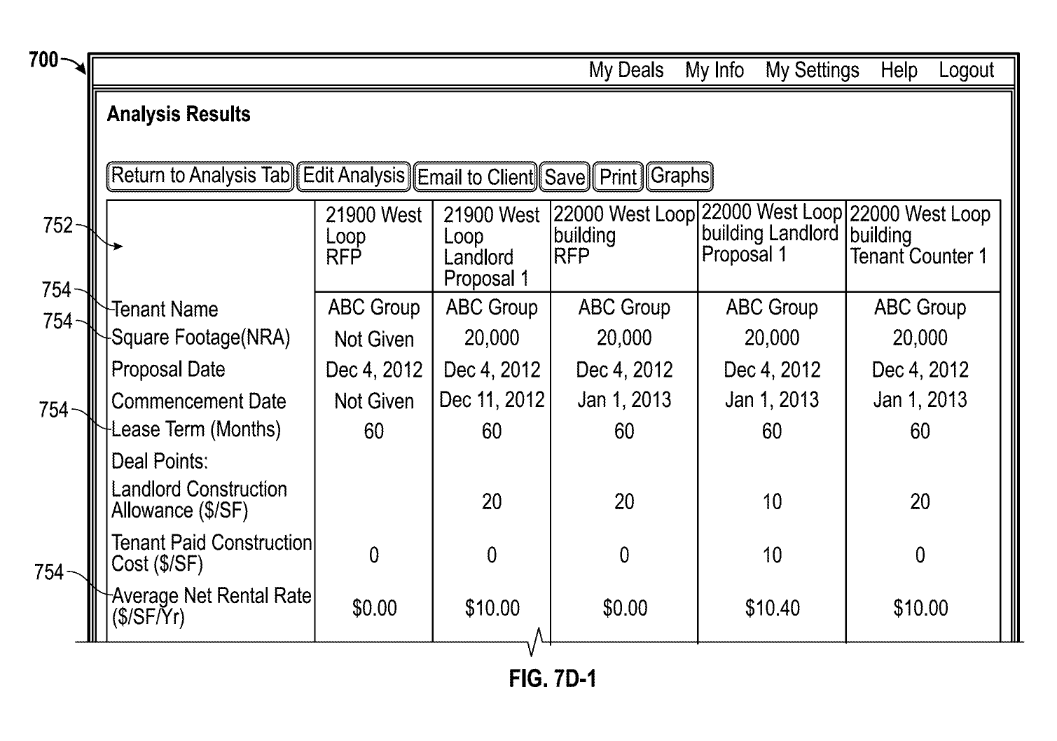

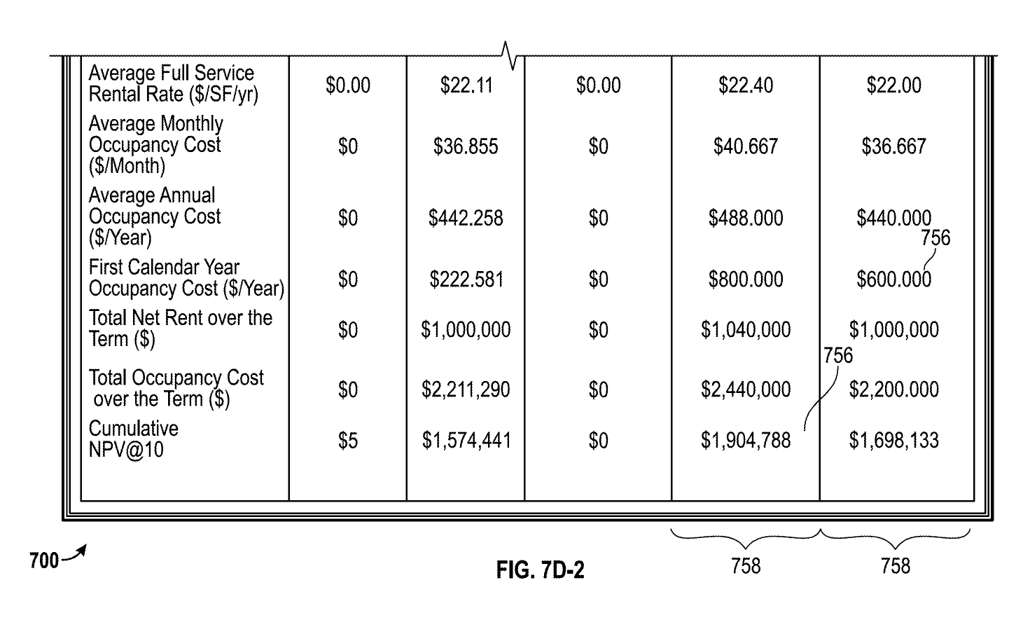

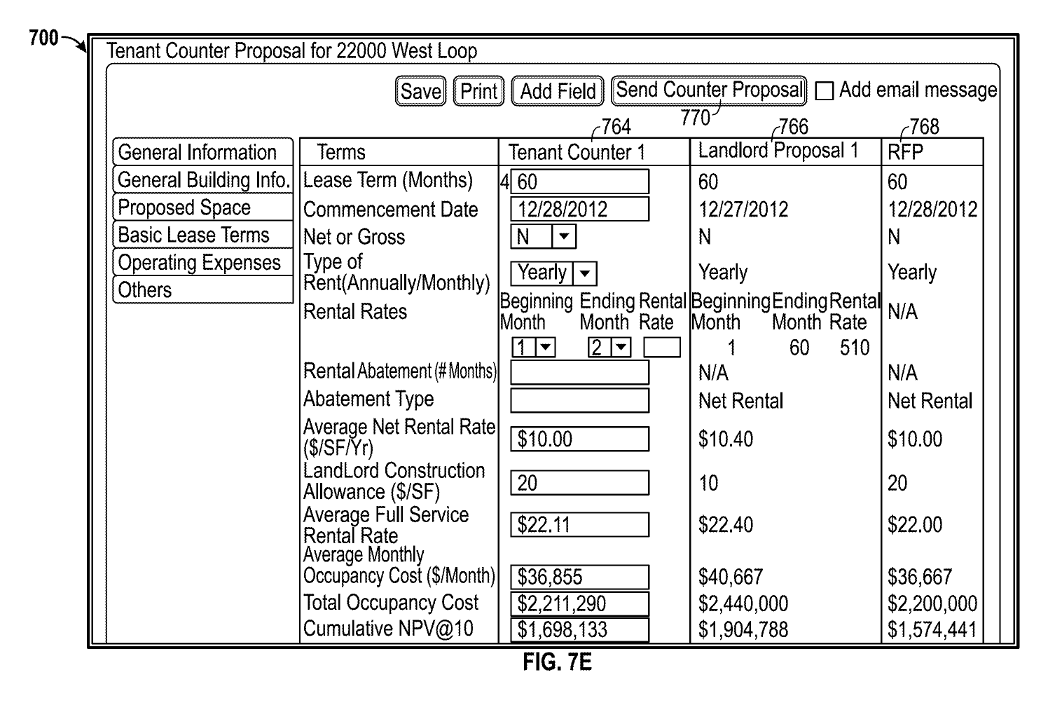

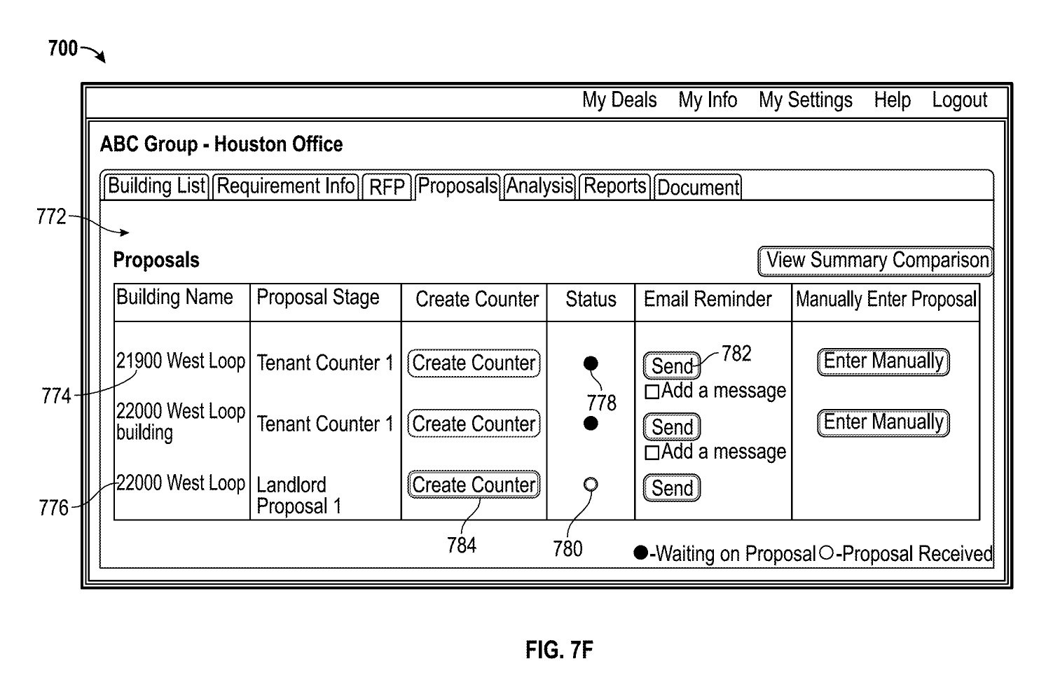

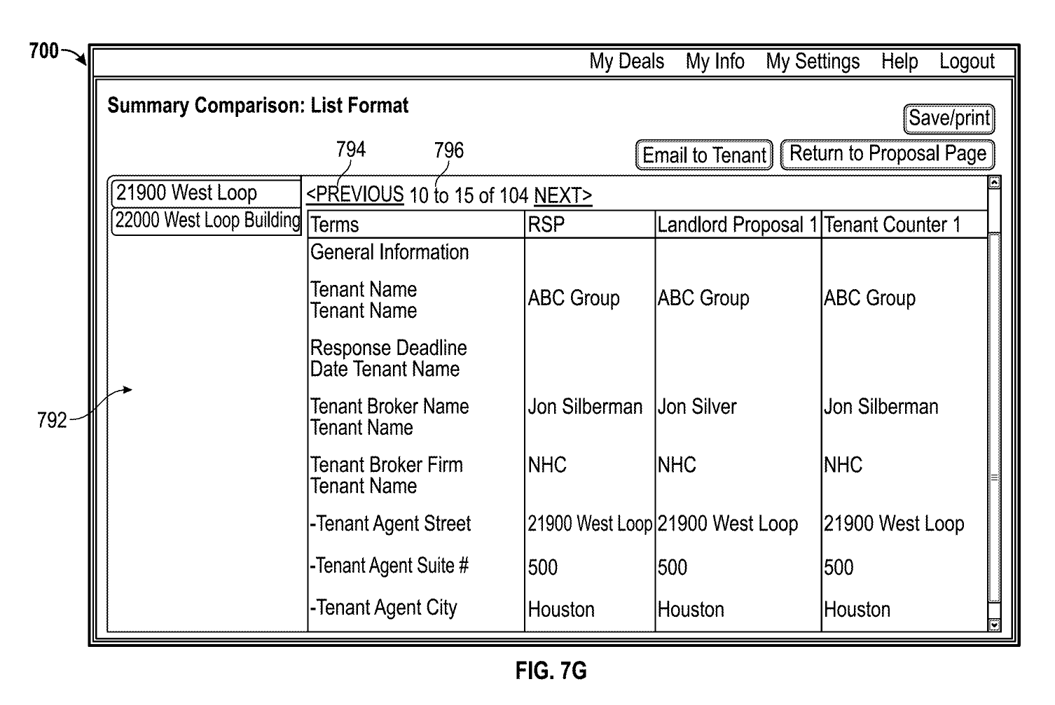

The analysis engine 232 may detect differences in the iterative proposals between the parties. The analysis engine 232 may also generate comparisons illustrating these differences. The comparison is a data set that, when interpreted by the GUI module 240 and rendered by a client device, provides graphical or auditory cues characterizing a state of progress of a negotiation. For example, a comparison may summarize pre-defined or selected key information relating to the negotiation—either generally, or from the perspective of either the procuring party or the property holding party—while highlighting aspects of the terms of a transaction which have yet to be agreed upon (i.e., non-matching parameters). Highlighting non-matching parameters may be carried out using a first indicia (e.g., text color). Parameters which have changed since the last proposal from a party may be highlighted using a second indicia (e.g., an arrow). In another example, iterations of proposals from the parties may be displayed so that progression of the negotiation is readily ascertained, as illustrated in greater detail below with regard to FIGS. 7A-G.

Parameters may be compared to historical or trend information and parameters lying outside of a normal range or contract provisions containing unusual terms may be highlighted using a third indicia for positive outliers or a fourth indicia for negative outliers. For example, a below-average cost per square foot based on averages from completed transactions in the previous month in the same area may be highlighted with a happy face or a green light for a procuring party display, but the presence of an undesirable parameter value may be displayed with a stop sign graphic or an audible alert.

The analysis engine 232 may also pass detected differences in the iterative proposals to the action generator 234. The action generator 234 compares iterative proposals by one or more parties and/or the detected differences therein against a set of negotiation rules to synthesize an optimal counterproposal. The action generator 234 may also use historical data, reference data, prior transaction data, data derived from aggregated prior transaction data, negotiation histories of the current procurement party and/or property holder party, and so on, in synthesizing the counterproposal. These data may be stored locally or in network attached storage in various databases (e.g., procurement party database 226, property holder party database 236, completed transaction database 246, etc.) using various database management systems (‘DBMS’) (225, 235, 245, etc.) or may be obtained from informational servers outside the system. For example, the London Interbank Offered Rate (‘LIBOR rate’) may be obtained from a financial website, or national economic statistics (e.g., foreclosure statistics) may be obtained from a governmental website, and so on.

Graphical user interface (‘GUI’) module 240 formats information from negotiation management module 230 for rendering at a client device, including procurement data sets associated with a procurement party and representing at least part of a procurement real estate proposal for real property, and a property holder data sets associated with a property holder party and representing at least part of a property holder real estate proposal for the real property. Data may be formatted as propriety or non-proprietary data sets for specially configured rendering by client software on the client device, or as HTML, XHTML, Flash, or other web-compatible data formats for rendering with a web browser such as Mozilla Firefox, Opera, Google Chrome, or Microsoft Explorer. A data set may be formatted for rendering on a particular client device which will receive it. Communications module 260 works with GUI module 240 to send data sets for rendering at other devices. Communications module 260 may also receive and dispatch submitted proposals and commands meant for other modules. Communications module 260 includes a network stack. GUI module 240 and/or communications module 260 may be implemented as a separate application server in some embodiments.

Activity in communications module 260 and other modules is overseen by security module 250. Security module 250 may also conduct authentication and authorization procedures for anyone logging into the platform 220 or for received proposals, and may also examine proposals or other information received at platform 220 for security issues (e.g., malware, hacking attempts).

The real estate transaction platform may include support tools 224. Support tools 224 may include graphical interaction or command line tools to adjust presentation, display, and/or analysis of the data. Support tools 224 may generate or modify configuration data related to the user account. The negotiation management module 230 may include programs that, when executed by a processor, may provide analysis of one or more of the data fields, including combination and comparison of data from one or more of the data sets in dependence upon information from the configuration information supplied by the support tools module. Management module 222 allows configuration and management of platform 220 on a system-wide scale. System updates or other administrator-level actions may be performed using the management module 222.

The listing engine 252 administers listing of properties from sellers or landlords. The subscriptions module 256 enables customers (buyers, sellers, tenants, landlords, and/or their agents) to subscribe to various services of the system, collects revenues, records account history, facilitates used of subscribed functions, and administers a database of subscribers which the security module may use to enable system access. Advertising engine 254 facilitates the storage and access of advertisements (e.g., banners, pop-ups, etc.) for use in conjunction with rendered content such as proposals, negotiation analysis, and comparisons; tracks advertisement statistics relating to display and conversion; and includes an advertising billing system. Scheduling module 256 enables scheduling of tours of the real property with agents. Agents are notified (e.g., by email) of requests from procurement parties to tour the real property. The system may also enable invitations from property holder parties to procurement parties to tour a property. The system provides the notifications and tracks the responses, preventing double booking of agents or properties if undesired, and providing graphical user interfaces (e.g., schedules, calendars) for viewing and managing the information.

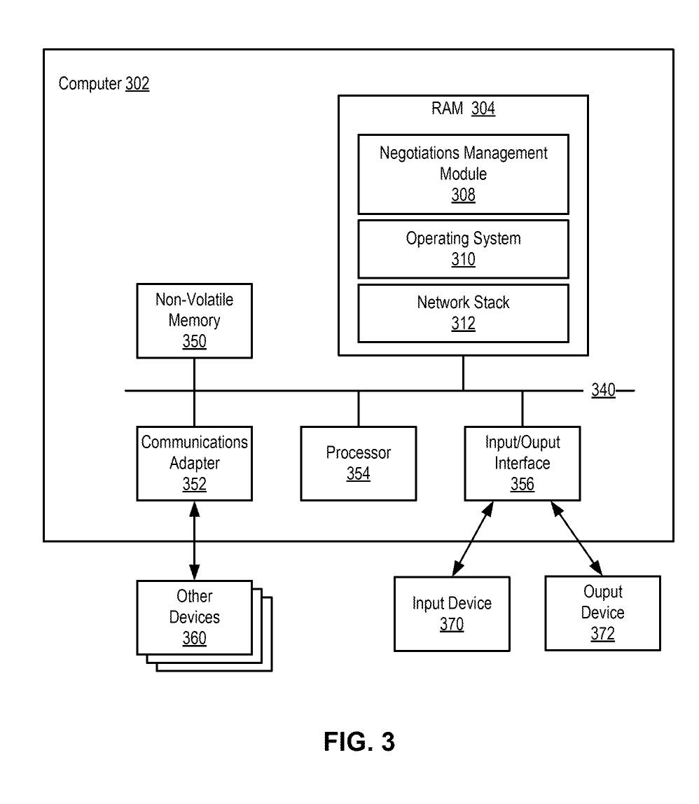

The real estate negotiation management platform may implement databases in data storage. The data storage may include any non-transitory computer-readable medium, either remotely or locally accessible, implemented with architectures including but not limited to cloud storage, network attached storage, storage area networks, etc. FIG. 3 sets forth a block diagram of an example information processing device used in embodiments of the present disclosure. Computer 302 includes at least one computer processor 354 as well as a computer memory, including both volatile random access memory (‘RAM’) 304 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 340 to the processor 354 and to other system components. Thus, the software modules are program instructions stored in computer memory.

An operating system 310 is stored in computer memory. Operating system 310 may be any appropriate operating system such as Windows XP, Windows 7, Mac OSX, UNIX, or LINUX. A network stack 312 is also stored in memory. The network stack 312 is a software implementation of cooperating computer networking protocols to facilitate network communications.

Computer 302 also includes one or more input/output interface adapters 256. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

Also stored in computer memory is a real estate negotiation management module 308. The real estate negotiation management module 308 may include device-specific computer program instructions for implementing real estate transaction management. Real estate negotiation management module 308 may be implemented, in part, as a web browser or email client application running on a desktop or workstation operated by a user. Alternatively, real estate negotiation management module 308 may comprise an integrated system application with modules running on multiple coordinated processors. Real estate negotiation management module 308 may also be implemented, in part, as server applications running on an application server. Module functionality is different between different devices of FIG. 2, such as client device 202, server brokerage server 204, and platform 220. Although embodiments are described above wherein client devices are separated from the platform by a brokerage server, in other embodiments, client devices may communicate directly with RENM platform 220. Module 308 on platform 220 operates to provide real estate management services to multiple clients or browsers as described above with reference to FIG. 2 (e.g., generating a negotiation analysis dataset, etc.) using modules as described with reference thereto.

Module 308 may be implemented as one or more sub-modules operating in separate software layers or in the same layer. Some modules or functionality described in connection with RENM platform 220 may be implemented in brokerage servers 202, 212. For example, specific party information may be stored at the brokerage servers, and manipulation and configuration of proposals may be enabled by software modules executing on the brokerage servers, which then transmit data sets to the RENM platform 220 for analysis.

In some aspects, the real estate negotiation management platform 220 may be configured to receive and store part or all of a data set through manual input or through uploading of data from another computer resource or storage medium. Data that is received and/or generated by the real estate transaction platform may be displayed to the user. In some embodiments, the user may be any of the parties, however, the real estate transaction platform may include security features that restrict specific users from viewing certain aspects of the data or using specific support tools that may be restricted. The format of the displayed data sets may be formatted, modified, or restricted based on the identity of the user.

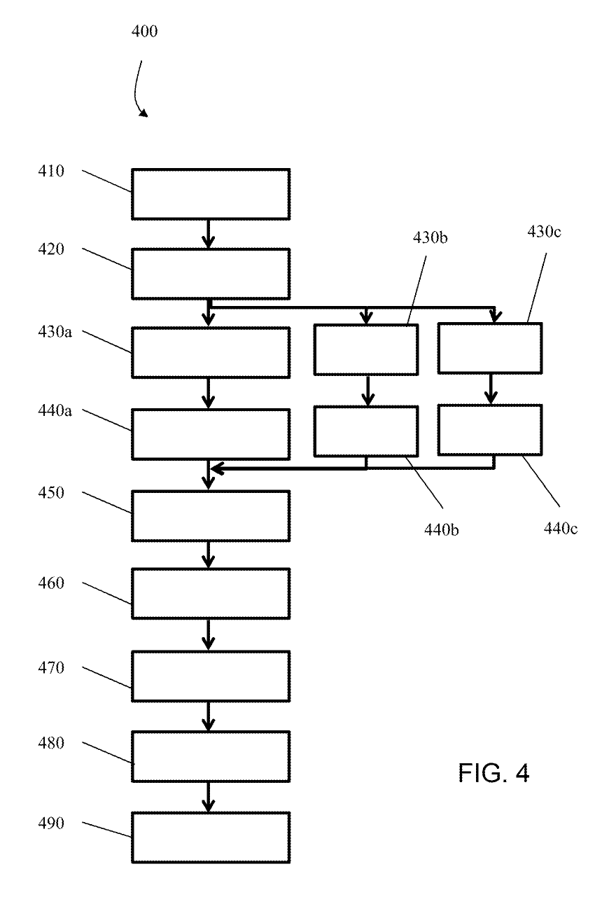

FIG. 4 shows a flow chart 400 of an example method of conducting a real estate transaction according to one embodiment of the present disclosure. In step 410, a first data set may be obtained. The first data set may include request for proposal (‘RFP’) data prepared by a first party (tenant, tenant agent, etc.). Communication of data sets between the first party and other parties may take place using the RENM platforms 101, 220 of FIGS. 1 & 2. In step 420, the first data set may be communicated to the one or more second parties (landlord, landlord agent, etc.). In step 430a, the first data set may be received by a second party. In step 440a, a response from the second party may be communicated to the first party. The response from the first landlord in step 440a may constitute a second data set. In step 450, the second data set may be received by the first party. In step 460, one or more analysis tools of the real estate transaction communication platform may generate analysis data based on at least part of one of: the first data set and the second data set. In step 470, at least part of the analysis data may be displayed for the first party.

Generating analysis data may be carried out by generating a negotiation analysis 120, 130. The negotiation analysis may include a comparison between the procurement data set and the property holder data set; a comparison between the at least one negotiation analysis data set and at least one of i) the procurement data set, and ii) the property holder data set; and so on. The comparison is a graphical indicator of differences between proposals, which may include all, a standard subset, or a specifically selected set of proposal information or contract text including graphical difference indicia such as, for example, differences in font, text color or background color; underlining; arrows; symbols; text summaries; stylistic changes; and so on. The comparison may include charts or graphs illustrating differences between proposals, indicia illustrating differences in text from comparable provisions, summaries illustrating differences in contract provisions, and so on.

Generating a negotiation analysis may include generating a negotiation analysis data set by analyzing the data sets from the first party and the second party. The data sets may include a procurement data set associated with a procurement party, and a property holder data set associated with a property holder party.

Generating analysis data may be carried out by providing a subsequent data set representing a counterproposal to at least one of the proposals. The subsequent data set may be incorporated into or illustrated by the negotiation analysis. The negotiation analysis data set may be generated by modifying a proposal from a previous iteration or a negotiation analysis using additional proposal information, which may include information supplied by one of the parties, reference information, current economic or market information, and so on.

The counterproposal represented by the subsequent data set may be an estimated optimal counterproposal. The estimated optimal counterproposal may be a suggested counterproposal synthesized according to rules adapted to provide a beneficial outcome to the negotiation, as described above. Generating analysis data may include generating an estimated optimal counterproposal in dependence upon statistical information derived from an aggregation of stored negotiation information pertaining to parties of prior negotiations; a stored negotiation history of at least one of the procurement party, and the property holder party; the procurement data set; the property holder data set; at least one subsequent data set representing a counterproposal; and the like.

In some embodiments, steps 460 and 470 may be optional. In step 480, a third data set may be generated. The third data set may include data from at least one of: the first data set, the second data set, the analysis data set, and user provided data. In step 490, the third data set may be communicated to the second party. In some embodiments, the third data set may include a counterproposal to the response communicated by the second party in step 440a. This method 400 may include one or more iterations. The method may repeat steps 420-490 with a new group of proposals and counterproposals. In later iterations, data sets available from earlier iterations may be used in the generation of later data sets and analysis data. The analysis data may include a trend of proposal data from different iterations.

In some embodiments, the first data set may be transmitted to additional third parties as shown in steps 430b, 430c and additional data sets may be communicated to the first party for one or more third parties as shown in steps 440b and 440c. The number of parallel transmissions by second parties may depend on the number of second parties, thus, in some embodiments, steps 430b, 430c, 440b, and 440c may be optional. In embodiments where third parties supply proposals (additional data sets), step 460 may include comparing the one or more of the response data sets (second and additional data sets), and step 470 may include displaying analysis data for the response data sets, either separately or in combination, and analysis data derived from comparing the data sets. The communication, in step 420, of the first data set to three second parties is example and illustrative only, as any number of second parties may receive the first data set in step 420. Communication between the parties may include forms of data transmission as understood by those of skill in the art, including but not limited to, physical mail, electronic mail, file transfer, and storage in a commonly accessible memory location.

In some embodiments, step 470 may include parallel substeps (not shown) where the first party may display response data sets from one or more iterations for a single responding party or multiple responding parties. In some embodiments, the number of iterations may be the same for each of the responding parties. In some embodiments, the number of iterations for one responding party may different from the number of iterations for at least one other responding party.

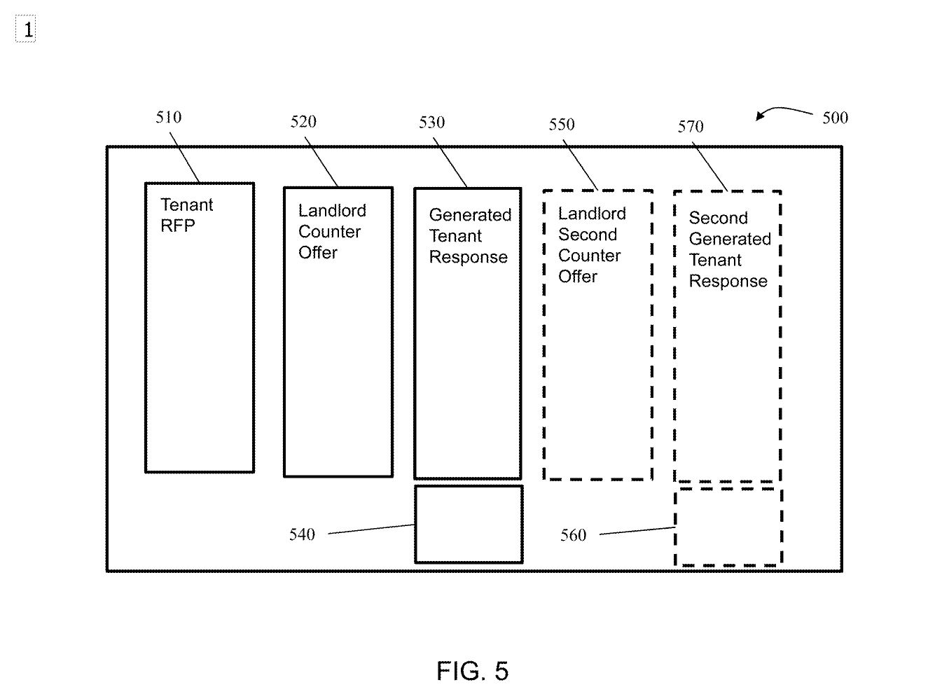

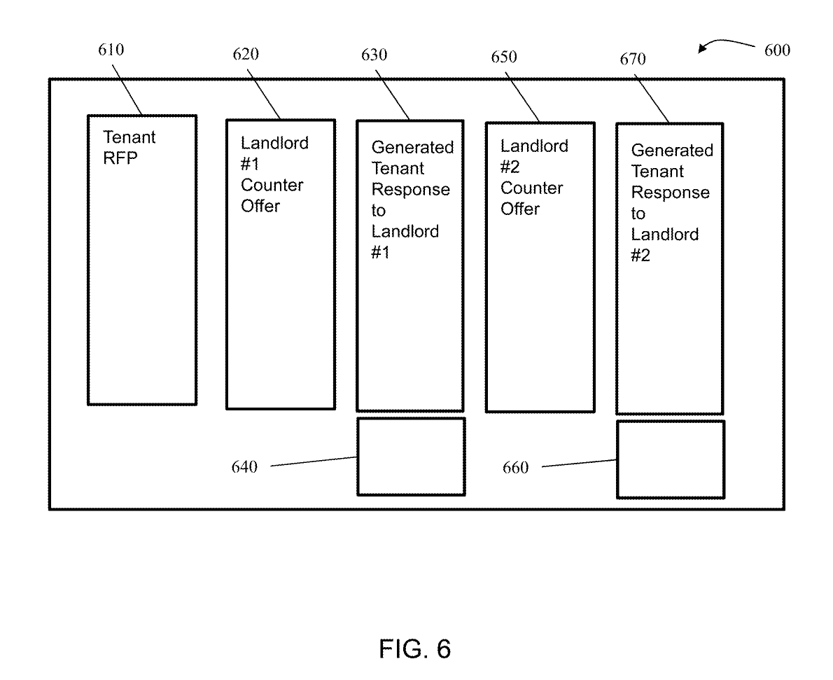

FIG. 5 shows an example display of real estate data according to one embodiment of the present disclosure. The display 500 may include one or more of: at least part of the first data set, at least part of the second data set, at least part of the third data set and at least part of the fourth data set. In this example embodiment, at least part of the first data set may be displayed and may include data associated with a tenant request for proposal 510; at least part of the second data may be displayed and may include data associated with a reply (counter-offer) from a landlord 520; at least part of the third data may be displayed and may include data generated as a response to the reply of the first landlord 530. The response 530 may be, at least in part, generated based on at least one of: i) the request for proposal 510 and ii) the reply of the first landlord 520. At least part of analysis data 540 may be generated using one or more of data sets 510, 520. Analysis data 540 may be displayed for the user as displayed analysis data. In some embodiments, the analysis data 540 may be based on displayed portions of data sets 510, 520, 530. In other embodiments, the analysis data 540 may be based on at least one part of the three data sets 510, 520, 530 that was not displayed. In some embodiments, the analysis module 230 may be configured to receive user inputs and display results in analysis display 540. The displayed third data set 530 may be modified based on displayed analysis data 540, other analysis data, external data, and/or manual user inputs.

In the example embodiment of FIG. 5, the generated tenant response 530 may be sent to the landlord and result in a second counter offer. At least part of the second counter offer may be displayed as a landlord counter-offer 550. This new iteration may result, if the second counter offer is not accepted by the tenant, in second generated tenant response data. At least part of the second generated tenant response data may be displayed 560. In some embodiments, the analysis module may generate an analysis based on the prior data sets and the second landlord counter-offer and display a second analysis 570. The display of data sets 510, 520, 530, 550, 560 and analysis data sets 540, 570 may be modified to present the information in a manner that is useful to a person of skill in the art. The parts of displayed data 510, 520, 530, 540, 550, 560, 570 may be formatted for ease of comparison and/or to indicate a progression of the negotiation through various iterations. In some embodiments, data sets not related to a specific party may not be displayed. In some embodiments, the display of analysis 540, 570 may be optional. In some embodiments, the generated tenant response display 530 may be populated from the tenant request for proposal display 510.

FIG. 6 shows an example display of real estate data according to one embodiment of the present disclosure. The display 600 may include at least part of the first data set, at least part of the second data set, at least part of the third data set, at least part of a fourth data set, at least part of a fifth data set, at least part of a sixth data set, and at least part of the seventh data set. In this example embodiment, the first data set may include data associated with a tenant request for proposal 610; the second data set may include data associated with a reply (counter-offer) from a first landlord 620; the third data set may generated based on at least part of one or more of: the first data set 610 and the second data set 620; a fourth data set may include analysis data 640 based on one or more of: the first data set 610, the second data set 620, and external data; the fifth data set may include data associated with a reply (counter-offer) from a second landlord 650; the sixth data set may include analysis data 660 based on one or more of: the first data set 610, the fifth data set 650, and external data; and the seventh data set may include data generated as a response to the reply of the second landlord 670. In some embodiments, seventh data set 670 may be identical to the third data set 630. The response 640 may be, at least in part, generated based on at least one of: i) the request for proposal 610 and ii) the reply of the first landlord 620. The parts of data 610, 620, 630, 640, 650, 660, 670 may be formatted for ease of comparison or to indicate a progression of the negotiation through various iterations. In some embodiments, data sets not related to a specific party may not be displayed. For example, if the tenant desires to only view data related to negotiation with the first landlord, parts of data sets 610, 620, 630, and 640 may be displayed, and data sets 650, 660, and 670 may be excluded.

For further explanation, FIGS. 7A-7G set forth an exemplary client graphical user interface (‘GUI’) for real estate transaction management in accordance with embodiments of the invention. FIG. 7A sets forth a line drawing of a browser 700 in a display module operating in accordance with methods described above and displaying a proposal generation screen 702. The proposal generation screen 702 is designed to receive information from a user and enable generation of a proposal in dependence upon the information received in accordance with the methods described above. The example proposal generation screen 702 includes input widgets for input of proposal parameters. Hierarchal list collapse widgets 704 allow subgroups of parameters to be viewed or hidden by toggling their display on or off. Checkbox widgets 706 allow specific parameters (or “terms”) to be included in the proposal by toggling their inclusion on or off. Some widgets 710, 712 display predefined menu choices for proposal parameters. Input widgets 710-716 are GUI widgets that accept inputs through a user's mouse click on one of the preferences displayed in the menu. Other widgets 708, 718 display and allow entry of numerical or text values representing proposal parameters in a text box. A “Save” button 720 will store the proposal for later use when selected. The proposal may be generated from the user input upon selection of the “Save” button, but may also be generated prior to this selection.

FIG. 7B sets forth a line drawing of a browser in a display module operating in accordance with methods described above and displaying a proposal management screen 722. The proposal generation screen 722 is designed to enable management of a proposal in accordance with the methods described above. The proposal management screen 722 displays a summary of outstanding proposals categorized by type. Type may relate to iteration or industry standard categories for proposals, such as RFP, offer, counteroffer, and so on. Proposal management screen 722 is organized in a context of tabbed virtual pages. The user may select a virtual page 732 for display and interaction by using the graphical user interface to select the corresponding tab 726. FIG. 7B shows a virtual page 732 displaying a summary of RFP type proposals.

The example proposal generation screen 722 may include icons or other widgets for initiating actions. Some widgets may be available in the context of a specific virtual page 732 for generating actions logically consistent with the page context, such as a “Send RFP” button 724 and “Resend RFP” button 730, enabling submission of the proposal to the other party, and “Modify RFP” button 728 for editing a generated proposal, each of which is available in the context of the specific virtual page 732 relating to RFP management.

FIG. 7C sets forth a line drawing of a browser in a display module configured to provide a negotiation analysis data set in accordance with methods described above and displaying a negotiation analysis screen 742. The negotiation analysis screen 742 displays a succession of proposal iterations 744, 746, 748. The proposal iterations are represented as parameter values displayed as attribute values (e.g., $10.00) in columnar form, with each attribute value of each iteration in a row corresponding to the attribute (e.g., Average Net Rental Rate). In FIG. 7C, the proposal iterations include proposals from a procurement party (RFP 744 and Tenant Counter-1 748) and from a property holder party (Landlord Proposal-1 746). In other embodiments, proposal iterations may include proposals from multiple procurement parties, multiple property holder parties, or both. Negotiation analysis screen 742 is designed to characterize a state of progress of a negotiation so that progression of the negotiation is readily ascertained.

FIG. 7D sets forth a line drawing of a browser in a display module operating in accordance with methods described above and displaying a negotiation analysis screen 752. The negotiation analysis screen 752 is designed to provide a comparison of current proposals from the other party in column and row format in accordance with the methods described above. Each proposal 758 is represented as a set of parameter values 756 displayed in a columnar format with common parameters 754 displayed in the same row.

FIG. 7E sets forth a line drawing of a browser in a display module operating in accordance with methods described above and displaying a counterproposal screen 762. The counterproposal screen 762 is designed to enable generation of a counterproposal in accordance with the methods described above. The counterproposal screen 762 displays a succession of proposal iterations 766, 768. A counterproposal form 764 for entering parameters may be displayed in relation to the proposal iterations. The counterproposal form 764 may incorporate an estimated optimal counterproposal. In FIG. 7E, the counterproposal form is displayed having one or more text fields pre-filled with estimated optimal values of the estimated optimal counterproposal. The user may interact with the GUI to modify or delete the values before submitting the counterproposal using the “Send Counter Proposal” button 770, or leave the default values as presented for submission.

The proposal iterations and the counterproposal form may be represented as parameter values displayed as attribute values (e.g., 60) in columnar form, with each attribute value of each iteration in a row corresponding to the attribute (e.g., Lease Term). However, some parameters (Beginning Month, Ending Month and Rental Rate, for example) may be presented in the same row. In FIG. 7E, the proposal iterations include proposals from a procurement party (RFP 768) and from a property holder party (Landlord Proposal-1 766). In other embodiments, proposal iterations may include proposals from multiple procurement parties, multiple property holder parties, or both. Counterproposal screen 762 may be designed to characterize a state of progress of a negotiation so that progression of the negotiation is readily ascertained.

FIG. 7F sets forth a line drawing of a browser in a display module operating in accordance with methods described above and displaying a status screen 772. The status screen 772 displays outstanding proposals 774, 776 along with an indication 778, 780 of whether a counter party has responded to a proposal. The status screen is designed to provide notice of negotiations requiring attention. If an indication 778 reflects that a response has not been received, the user may select the corresponding “Send” button 782 to send an email reminder to the counterparty. If an indication 780 reflects that a response has been received, the user may select the corresponding “Create Counter” button 784 to initiation generating a counter proposal, such as, for example, by navigating to the counterproposal screen 762 above.

FIG. 7G sets forth a line drawing of a browser in a display module operating in accordance with methods described above and displaying a proposal summary screen 792. The proposal summary screen 792 displays a summary of all outstanding proposals categorized by building. The proposal summary screen is designed to provide a comparison of iterative changes to proposals in a negotiation over time. Client GUI 700 also includes icons for initiating actions, such as a “Previous” button 794 and “Next” button 798 for switching between virtual pages of the display containing distinct summaries. Number indicator 796 may illustrate the particular virtual page being displayed or the summary numbers displayed on the current particular page being viewed. One or more than one summary may be found on each page in list format. Building tab buttons 790 may be selected to provide a set of summaries for the specific building.

Although specific GUI embodiments are disclosed above, it should be readily apparent that various additions and modifications to these embodiments may be carried out as would occur to those of skill in the art such that the resulting graphical user interfaces fall within the scope of the claims. Elements of the specific screens or pages above may be combined in new ways. In various embodiments, summaries of outstanding proposals may be further categorized by proposal type. Proposal type may include a submitting party, a receiving party, a counterparty, a procurement party or collections thereof, a property holder party or collections thereof, a specific iteration, or combinations of these. Proposal datasets or the information therein may be filtered and sorted in various ways for presentation. Templating or saving of work in progress may be implemented as is known in the art. These and other insubstantial modifications are within the scope of the claimed invention. In some aspects, the data may include characteristics of future properties, including sales and new construction, as well as, existing properties. Relevant data may include information relevant to the parties for making a decision about lease or purchase of a property. The property may be for sale or lease.

A procurement party or a property holder may be soliciting for another party or representing another party. A party to the transaction may be a tenant or an agent of a tenant and a second party to the transaction may be a landlord or an agent of a landlord. In some aspects, the real estate transaction parties may include one or more of brokers, tenants, and owners, representatives of brokers, tenants, and owners, and additional relevant persons or entities as understood by one of skill in the art. The various parties may desire or find use in identical or non-identical sets of data about the property that is the subject of the real estate transaction. For reasons of confidentiality and/or security, some parts of the data sets may need to be restricted from one or more of the parties.

Herein, data may include, but is not limited to, one more of: raw data and processed data. The data may be related real estate transactions generally. In some embodiments, the data relates to commercial real estate.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A method for real estate transaction management, the method being performed by execution of a computer-readable program code by at least one processor of at least one computer system, the method comprising:
generating at least one negotiation analysis data set using the at least one processor to analyze:
a procurement data set associated with a procurement party and representing at least part of a procurement real estate proposal for real property, and
a property holder data set associated with a property holder party and representing at least part of a property holder real estate proposal for the real property; and
providing at least part of the negotiation analysis data set to at least one of i) the procurement party, ii) an agent of the procurement party, iii) the property holder party, and iv) an agent of the property holder party.

2. The method of claim 1, further comprising modifying the negotiation analysis data set using additional proposal information.

3. The method of claim 1, further comprising generating a subsequent data set representing a counterproposal to at least one of i) the procurement party real estate proposal, and ii) the property holder real estate proposal using at least a portion of the negotiation analysis data set.

4. The method of claim 1, wherein the negotiation analysis data set comprises an estimated optimal counterproposal.

5. The method of claim 4, further comprising storing negotiation information pertaining to parties of prior negotiations, and wherein the estimated optimal counterproposal is generated in dependence upon statistical information derived from an aggregation of stored negotiation information.

6. The method of claim 4, further comprising storing negotiation information pertaining to parties of prior negotiations as a negotiation history associated with a respective party of the parties of prior negotiations, and wherein the estimated optimal counterproposal is generated in dependence upon a stored negotiation history of at least one of i) the procurement party, and ii) the property holder party.

7. The method of claim 4, wherein the estimated optimal counterproposal is generated in dependence upon at least one of i) the procurement data set, and ii) the property holder data set; and at least one subsequent data set representing a counterproposal.

8. The method of claim 1, wherein generating the at least one negotiation analysis data set further comprises generating a comparison between the procurement data set and the property holder data set.

9. The method of claim 1, further comprising generating a comparison between at least a portion of one of the at least one negotiation analysis data set and at least one of i) the procurement data set, and ii) the property holder data set.

10. The method of claim 1, wherein providing the at least part of the negotiation analysis data set further comprises:
displaying the at least part of the negotiation analysis data set.

11. The method of claim 10, wherein providing the at least part of the negotiation analysis data set further comprises:
displaying at least one of: (i) a part of the procurement data set and (ii) a part of the property holder data set.

12. The method of claim 1, wherein generating at least one negotiation analysis data set further comprises:
using the processor to further analyze at least one additional data set comprising at least one of i) an additional procurement data set associated with an additional procuring party, and ii) an additional property holder data set associated with an additional property holder party.

13. The method of claim 1, wherein the property is a commercial real estate property.

14. The method of claim 1, wherein the real estate proposals relate to leasing of the property.

15. The method of claim 1, wherein the real estate proposals relate to buying of the property.

16. The method of claim 1, wherein the property holder real estate proposal is in response to the procurement real estate proposal.

17. The method of claim 1, wherein the procurement real estate proposal is in response to the property holder real estate proposal.

18. A system for real estate transaction management, the system comprising:
a real estate negotiation management platform comprising at least one processor;
a procurement brokerage server in communication with the real estate negotiation management platform, the procurement brokerage server configured to submit a procurement data set associated with a procurement party and representing at least part of a procurement real estate proposal for real property;
a property holder brokerage server in communication with the real estate negotiation management platform, the property holder brokerage server configured to submit a property holder data set associated with a property holder party and representing at least part of a property holder real estate proposal for real property;
wherein the real estate negotiation management platform is configured to:
generate, using the at least one processor, at least one negotiation analysis data set in dependence upon at least the procurement data set and the property holder data set; and
provide at least part of the at least one negotiation analysis data set to at least one of i) the procurement brokerage server, ii) the property holder brokerage server; and
wherein at least one of i) the procurement brokerage server and ii) the property holder brokerage server is configured to enable access of the at least one negotiation analysis data set to at least one of i) the procurement party, ii) an agent of the procurement party, iii) the property holder party, and iv) an agent of the property holder party.

19. The system of claim 18, further comprising:
a procurement party client device in communication with the procurement brokerage server, the procurement party client device configured to enable rendering of the at least one negotiation analysis data set;
a property holder party client device in communication with the property holder brokerage server, the property holder party client device configured to enable rendering of the at least one negotiation analysis data set; and
wherein at least one of i) the procurement brokerage server and ii) the property holder brokerage server is configured to enable access of the at least one negotiation analysis data set via rendering on at least one of i) the procurement party client device and ii) the property holder party client device.

20. The system of claim 19, wherein at least one of i) the procurement party client device and ii) the property holder party client device is configured to enable generation of at least one of i) the procurement data set and ii) the property holder data set.

21. A system for real estate transaction management, the system comprising:
a real estate negotiation management platform comprising at least one processor;
a procurement party client device in communication with the real estate negotiation management platform, the procurement party client device configured to submit a procurement data set associated with a procurement party and representing at least part of a procurement real estate proposal for real property;
a property holder party client device in communication with the real estate negotiation management platform, the property holder party client device configured to submit a property holder data set associated with a property holder party and representing at least part of a property holder real estate proposal for real property;
wherein the real estate negotiation management platform is configured to:
generate, using the at least one processor, at least one negotiation analysis data set in dependence upon at least the procurement data set and the property holder data set; and
provide at least part of the at least one negotiation analysis data set to at least one of i) the procurement brokerage server, ii) the property holder brokerage server; and
wherein at least one of i) the procurement party client device and ii) the property holder party client device is configured to enable access of the at least one negotiation analysis data set to at least one of i) the procurement party, ii) an agent of the procurement party, iii) the property holder party, and iv) an agent of the property holder party.

22. A commercial real estate transaction system, the system comprising:
at least one processor; and
a non-transitory storage medium, the medium storing instructions thereon that, when executed, cause the at least one processor to:
generate, using the at least one processor, at least one negotiation analysis data set in dependence upon at least:
a procurement data set associated with a procurement party and representing at least part of a procurement real estate proposal for real property, and
a property holder data set associated with a property holder party and representing at least part of a property holder real estate proposal for the real property; and
provide at least part of the negotiation analysis data set to at least one of i) the procurement party, ii) an agent of the procurement party, iii) the property holder party, and iv) an agent of the property holder party.
